(19) United States
(12) Patent Application Publication
(10) Pub. No.: US 2025/0244966 A1
(43) Pub. Date: Jul. 31, 2025

(54) CREATING APPLICATIONS AND PROCESSING REQUESTS

(71) Applicant: Beijing Zitiao Network Technology Co., Ltd., Beijing (CN)

(72) Inventor: Yuyang Pan, Beijing (CN)

(21) Appl. No.: 18/651,747

(22) Filed: May 1, 2024

(30) Foreign Application Priority Data
Jan. 26, 2024 (CN) 202410117608.6

(51) Int. Cl. G06F 8/35; G06F 8/34; G06F 9/445

(52) U.S. Cl. CPC G06F 8/35; G06F 8/34; G06F 9/44526

(57) ABSTRACT

The present disclosure relates to methods, apparatuses, devices, and storage media for creating a target application. One method comprises: obtaining configuration information of a first processing entity associated with the target application to be created, the application to be created being associated with a plurality of processing entities, the configuration information indicating a target action performed by the first processing entity in response to determining that that the first processing entity is not suitable for processing a particular request; and creating a target application based on the configuration information. In this way, embodiments of the present disclosure are able to support users in configuring specific processing entities to perform actions in response to determining that the specific processing entity is not suitable for processing requests, thereby improving the reliability of the application.

### CROSS REFERENCE

This application claims priority to the Chinese patent application submitted on Jan. 26, 2024, with the application No. 202410117608.6 and the invention name “METHOD, APPARATUS, DEVICE AND STORAGE MEDIUM FOR CREATING APPLICATION AND PROCESSING REQUEST”. The entire content of this application is incorporated by reference incorporated in this application.

### FIELD

The example embodiments of the present specification generally relate to the field of computers, and more particularly to creating an application and processing a request.

### BACKGROUND

With the development of computer technology, people may create and publish various types of applications through different platforms. For example, with the development of machine learning technology, people may quickly create an application by configuring application parameters, such as a model used by an application, an available plug-in, etc.

### SUMMARY

In the first aspect of the present disclosure, a method of creating an application is provided. The method comprises: obtaining configuration information of a first processing entity associated with an application to be created, the configuration information indicating a target action to be performed by the first processing entity in response to a determination that the application to be created is not suitable for processing a request to be processed, and the application to be created is associated with multiple processing entities; and creating a target application based on the configuration information.

In the second aspect of the present disclosure, a method of processing requests is provided. The method comprises: receiving a target request for a target application; in response to a determination that a first processing entity associated with the target application is not suitable for processing the target request, based on the entity jump history of the target application, determining a second processing entity from a plurality of processing entities associated with the target application, the entity jump history indicating a historical jump process from a starting processing entity among multiple processing entities to the first processing entity; and switching to the second processing entity to process the target request.

In the third aspect of the present disclosure, an apparatus for creating an application is provided. The apparatus comprises: an obtaining module configured to obtain configuration information of a first processing entity associated with a target application to be created, the configuration information indicating a target action to be performed by the first processing entity in response to a determination that the target application to be created is not suitable for processing a request to be processed, the target application to be created being associated with a plurality of processing entities; and a creating module configured to create the target application based on the configuration information.

In the fourth aspect of the present disclosure, an apparatus for processing a request is provided. The apparatus comprises: a receiving module configured to receive a target request for a target application; a determining module configured to determine a second processing entity from a plurality of processing entities associated with the target application based on an entity jump history of the target application, the entity jump history indicating a historical jump process from a starting processing entity from the plurality of processing entities to the first processing entity, in response to determining that a first processing entity associated with the target application is not suitable for processing the target request; and a switching module configured to switch to the second processing entity to process the target request.

In the fifth aspect of the present disclosure, an electronic device is provided. The device comprises at least one processing unit; and at least one memory, at least one memory is coupled to at least one processing unit and stores instructions for execution by at least one processing unit. The instructions cause the device to perform the method of the first aspect or the second aspect when executed by at least one processing unit.

In the sixth aspect of the present disclosure, a computer-readable storage medium is provided. The computer-readable storage medium stores a computer program that may be executed by a processor to implement the method of the first aspect or the second aspect.

It should be understood that the contents described in this section are not intended to limit the key features or important features of the present disclosure, nor are they intended to limit the scope of the disclosure. Other features of the disclosure will become readily understood from the following description.

### BRIEF DESCRIPTION OF THE DRAWINGS

The above and other features, advantages and aspects of the various embodiments of the present disclosure will become more apparent in conjunction with the accompanying drawings and with reference to the following detailed description. In the drawings, same or similar reference numbers denote same or similar elements, wherein:

FIG. 1 shows a schematic diagram of an example environment.

FIG. 2 shows a flowchart of an example process of creating an application.

FIG. 3 illustrates an example interface.

FIG. 4 shows a flowchart of an example process of processing a request.

FIGS. 5A to 5C illustrate a schematic view of the update entity jump history.

FIG. 6A shows a schematic block diagram of an example apparatus for creating an application.

FIG. 6B shows a schematic block diagram of an example apparatus for processing requests.

FIG. 7 shows a block diagram of an example electronic device.

### DETAILED DESCRIPTION

The following will describe embodiments of the present disclosure in more detail with reference to the accompanying drawings. Although certain embodiments of the present disclosure are shown in the drawings, it should be understood that the present disclosure may be implemented in various forms and should not be interpreted as limited to the embodiments set forth herein. On the contrary, these embodiments are provided for a more thorough and complete understanding of the present disclosure. It should be understood that the accompanying drawings and embodiments of the present disclosure are for illustrative purposes only and are not intended to limit the scope of protection of the present disclosure.

It should be noted that the titles of any section/sub-section provided in this article are not restrictive. Various embodiments are described throughout this article, and any type of embodiment may be comprised under any section/sub-section. In addition, the embodiments described in any section/sub-section may be combined in any way with any other embodiments described in the same section/sub-section and/or different sections/sub-sections.

In the description of embodiments of the present disclosure, the term “comprising” and similar terms should be understood as open-ended inclusion, that is, “including but not limited to”. The term “based on” should be understood as “at least partially based on”. The term “one embodiment” or “the embodiment” should be understood as “at least one embodiment”. The term “some embodiments” should be understood as “at least some embodiments”. The following text may also include other explicit and implicit definitions. The terms “first”, “second” and the like may refer to different or identical objects. The following text may also comprise other explicit and implicit definitions.

The embodiments of the present disclosure may involve data of users, data acquisition and/or use, etc. These aspects comply with corresponding laws, regulations and relevant provisions. In the embodiments of the present disclosure, all data collection, acquisition, processing, handling, forwarding, use and the like are carried out under the premise that the user is aware of and confirms them. Correspondingly, when implementing the various embodiments of the present disclosure, the user should be informed of the types, usage scope, usage scenarios and the like of the data or information that may be involved and authorized by the user through appropriate means in accordance with relevant laws and regulations. The specific notification and/or authorization methods may vary according to the actual situation and application scenarios, and the scope of the present disclosure is not limited in this regard.

The scheme of the present specification and embodiment, supposing that it involves the processing of personal information, will be processed on the premise of having a legal basis (such as obtaining the consent of the personal information subject, or necessary for the performance of the contract, etc.), and will only be processed within the prescribed or agreed scope. The user's refusal to process personal information other than the necessary information required for basic functions will not affect the user's use of basic functions.

Traditionally, a user can configure a model, a plugin and the like used by an application to quickly create an application, such as bot. However, such an application usually corresponds to a single agent. Since an agent usually has stronger processing capabilities in a specific field, requests that applications may process are limited and it is difficult to effectively handle more complex requests.

The present disclosure proposes solutions for creating an application. According to one or more of these solutions, the configuration information of the first processing entity associated with the application to be created may be obtained. The configuration information indicates the target action performed by the first processing entity in response to that the application to be created is determined as being not suitable for processing the request to be processed. The application to be created may be associated with a plurality of processing entities. Furthermore, the target application may be created based on the configuration information.

In this manner, embodiments of the present disclosure are able to support the user to configure an action performed by a particular processing entity in response to a determination that the particular processing entity is not suitable for processing the request, thereby improving the reliability of the application.

Embodiments of the present disclosure further propose a solution of processing requests. According to the solution, target requests for target applications may be received. Furthermore, in response to a first processing entity associated with the target application determining that it is not suitable for processing the target request, a second processing entity is determined from a plurality of processing entities associated with the target application based on the entity jump history of the target application. The entity jump history indicates the historical jump process from the starting processing entity of a plurality of processing entities to the first processing entity. Correspondingly, the second processing entity may be switched to, to process the target request.

In this manner, upon determining that the processing entity is not suitable for processing a request to be processed, embodiments of the present disclosure may enable the selection of another processing entity to continue processing the request to be processed according to the entity jump history of the application. Therefore, embodiments of the present disclosure may improve the reliability of application processing requests.

The following further describes in detail various exemplary implementations of the scheme in conjunction with the accompanying drawings.

### Example Environment

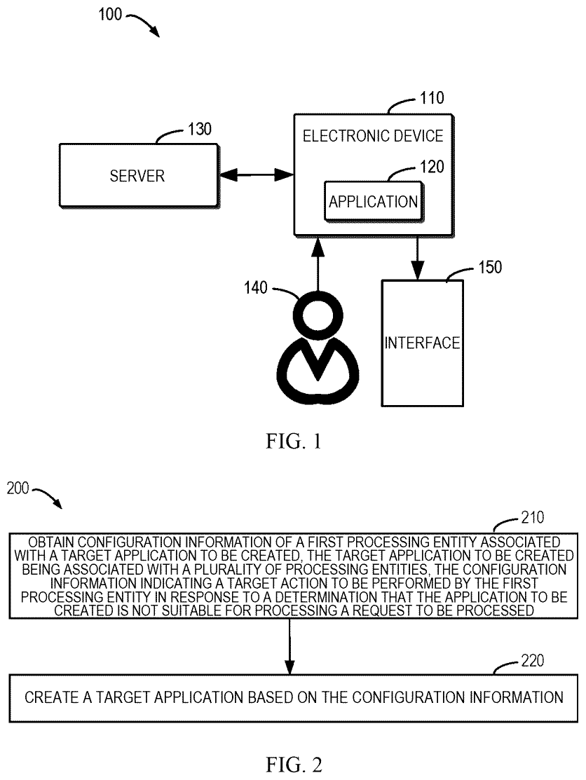

FIG. 1 shows a schematic diagram of an example environment 100 in which embodiments of the present disclosure may be implemented. As shown in FIG. 1, the example environment 100 may comprise an electronic device 110.

In the example environment 100, the electronic device 110 may run an application 120 that supports interface interaction. The application 120 may be any suitable type of application for interface interaction, examples of which may comprise, but are not limited to: developing an application or other suitable application that supports application development. The user 140 may interact with the application 120 via the electronic device 110 and/or its attached devices.

In the environment 100 of FIG. 1, if the application 120 is active, the electronic device 110 may present an interface 150 for supporting the creation of an application via the application 120.

In some embodiments, the electronic device 110 communicates with the server 130 to provide services to the application 120. The electronic device 110 may be any suitable type of mobile terminal, fixed terminal, or portable terminal, including, for example, a mobile phone, desktop computer, laptop computer, notebook computer, netbook computer, tablet computer, media computer, multimedia tablet, handheld computer, portable gaming terminal, VR/AR device, personal communication system (PCS) device, personal navigation device, personal digital assistant (PDA), audio/video player, digital cameras/camcorder, positioning device, television receiver, radio broadcast receiver, electronic book device, gaming device, or any combination thereof, including an accessory and a peripheral of these devices or any combination thereof. In some embodiments, the electronic device 110 may also support any type of user-specific interface (such as “wearable” circuit, etc.).

Server 130 may be an independent physical server, a server cluster or a distributed system comprising a plurality of physical servers, or a cloud server as a service provider that provides basic cloud computing services such as cloud service, cloud database, cloud computing, cloud function, cloud storage, network service, cloud communication, middleware service, domain name service, security service, content distribution network, and big data and artificial intelligence platform. Server 130 may comprise a computing system/server, such as mainframe, edge computing node, computing device in cloud environment, and so on. Server 130 may provide background service for application 120 that supports a virtual scenario in electronic device 110.

A communication connection may be established between the server 130 and the electronic device 110. The communication connection may be established by wired means or wireless means. The communication connection may comprise but is not limited to Bluetooth connection, mobile network connection, Universal Serial Bus (USB) connection, Wireless Fidelity (WiFi) connection, etc. The embodiments of the present disclosure are not limited in this regard. In the embodiments of the present disclosure, the server 130 and the electronic device 110 may achieve signaling interaction via the communication connection between the two.

It should be understood that the structure and function of each element in the environment 100 are described for illustrative purposes only, without implying any limitation on the scope of the present disclosure.

The following will continue to describe some example embodiments of the present disclosure with reference to the accompanying drawings.

### Application Creation Process

FIG. 2 shows a flow chart of an example process 200 for creating an application in accordance with some embodiments of the present disclosure. Process 200 may be implemented at an electronic device 110 for creating an application. Process 200 will be described below with reference to FIG. 1.

As shown in FIG. 2, at block 210, the electronic device 110 obtains configuration information of the first processing entity associated with the application to be created, the configuration information indicating a target action performed by the first processing entity in response to a determination that the application to be created is not suitable for processing the request to be processed. The application to be created is associated with a plurality of processing entities.

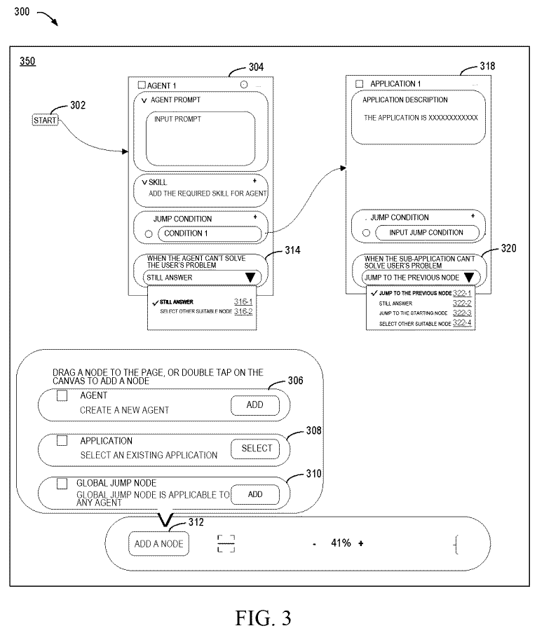

In some embodiments, the electronic device 110 may support configuration by the user of a plurality of processing entities (e.g., two or more processing entities) comprised in an application and jump relationships between processing entities to create an application. As will be described in detail below, such processing entities may comprise, for example, an existing application (also referred to as a referenced application) or an agent to be configured. The following will describe an example process of creating an application according to some example embodiments of the present disclosure with reference to FIG. 3.

In some embodiments, the electronic device 110 may provide an editing interface 300 as shown in FIG. 3. In the interface 300, the electronic device 110 may support a user creation of a node connection graph 350. The node connection graph 350 may comprise a starting node 302 and a plurality of nodes corresponding to a plurality of processing entities, e.g., a node 304 corresponding to “Agent 1” and the like. Additionally, electronic device 110 may further support providing an indication of the jump relationships between corresponding processing entities via adding connections between nodes.

In some embodiments, the electronic device 110 may support a user in creating a new application. As an example, the electronic device 110 may create a first initial connection graph based on a request to create a new application. Taking FIG. 3 as an example, the first initial connection graph comprises, for example, a first initial node (e.g., node 304). For the scenario of creating a new application, the property information of the first initial node (for example, node 304) may be empty. Furthermore, the electronic device 110 is able to create a final node connection graph 350 based on editing operation(s) on the first initial connection graph.

In some embodiments, the electronic device 110 may support a user in converting an existing application based on a single agent to an application based on multiple processing entities. Specifically, the electronic device 110 may create a second initial connection graph based on a conversion request for an existing application associated with a single agent.

In some embodiments, unlike in the scenario of creating a new application, the property information of the agent (e.g., Agent 1) corresponding to the second initial node may be determined, for example, based on the property of the existing application. That is, at least a part of the property information associated with the existing application may be synchronized to the newly created application.

In some examples, an agent automatically created by converting a single-agent-based application may inherit model information from the existing application. For example, if an existing application is implemented based on a specific model, the agent may also be implemented based on that model.

Continuing with reference to FIG. 3, the electronic device 110 may support a user to add a new node or a plurality of nodes to the node connection graph 350 via control 312. As shown in FIG. 3, the electronic device 110 may provide a plurality of controls for adding different types of nodes, such as control 306, control 308, and control 310.

In some embodiments, the user may add a new node corresponding to the new agent to the node connection graph 350 through the control 306. Similar to the node 304, the user may edit the property of the agent corresponding to the new node and may configure a jump relationship between nodes.

In some embodiments, upon receiving a selection of control 308, the electronic device 110 may provide a set of candidate applications that are available to be added. Accordingly, electronic device 110 may add one or more nodes corresponding to the one or more candidate applications to node connection graph 350 based on a user's selection of the one or more candidate applications. Illustratively, node 318 may correspond to the added application: “Application 1.”

The electronic device 110 may support users in configuring a jump condition between any two nodes. Such two nodes may comprise a node corresponding to an agent or a node corresponding to a referenced application.

As an example, as shown in FIG. 3, the electronic device 110 may also support a user to configure a connection relationship between nodes in the node connection graph 350, such as a connection between node 304 and node 318.

Specifically, as shown in FIG. 3, the electronic device 110 may establish a connection between the node 304 and the node 318 based on a user-configured jump condition associated with the node 304 (e.g., condition 1).

As an example, the connection may indicate a jump relationship between a processing entity corresponding to “Agent 1” and a processing entity corresponding to “Application 1”, indicating that “Agent 1” may switch to “Application 1” to process a request or perform a task if “condition 1” is met.

In some embodiments, the electronic device 110 may support the user to enter text content via the configuration control of the node 304 to define any appropriate jump conditions. As an example, the content of “Condition 1” may be, for example, “If the user queries about the weather.” Accordingly, “Agent 1” may switch to “Application 1” to respond to the query when it is determined that the user's query content is related to the weather.

In some embodiments, in order to support the jumping from “Agent 1” to “Application 1”, a jump plug-in corresponding to the jump condition (e.g., condition 1) from “Agent 1” to “Application 1” may be created. This enables “Agent 1” to independently determine whether the jump plug-in is required to use in the current scenario to perform the switching from “Agent 1” to “Application 1”. In some examples, in the case where “Agent 1” creates a jump condition, a suggested interaction item for “Agent 1” may also be generated based on the jump condition.

In some embodiments, for example, the electronic device 110 may also support the user to add only a connection between nodes without configuring a corresponding jump condition. For example, after the user configures the jump relationship from “Agent 1” to “Application 1”, “Agent 1” may determine whether to switch to “Application 1” based on the description information of “Application 1”.

As an example, such description information may indicate a capability of “Application 1”. For example, the description information of “Application 1” may indicate that “Application 1” is suitable for a task such as a weather query. Correspondingly, when “Agent 1” receives an inquiry about weather, it may determine that “Application 1” is suitable for processing the inquiry and switch to “Application 1”.

Considering that as the number of nodes increases, in some scenarios, users may expect to configure a global jump condition. As shown in FIG. 3, the electronic device 110 may also support users in configuring global jump information via the control 310. The global jump information may indicate that at least one other processing entity in the node connection graph, except for the target processing entity, is capable of switching to the target processing entity to process a request under a unified specific condition. In some embodiments, the global jump information may indicate that all processing entities in the node connection graph, except for the target processing entity, are capable of switching to the target processing entity to process a request under a unified specific condition. It should be understood that such target processing entities may correspond to agents or referenced applications.

In some embodiments, when the corresponding jump relationship is configured, during processing of the target request by the target application, in response to the target application switching from one processing entity (e.g., processing entity A) to another processing entity (e.g., processing entity B) to process the target request, context information associated with the processing entity A is provided to the processing entity B for processing the target request.

Taking the jumping from “Agent 1” to “Application 1” as an example, the historical conversation information between the user and “Agent 1” may be provided to “Application 1” as context information to improve the efficiency of “Application 1” processing tasks.

It should be appreciated that, although the jump between the agent to the application is described as an example of the configuration process of the jump condition, such a configuration process is equally applicable to an agent to agent jump, an application to application jump, or an application to agent jump.

In some embodiments, the electronic device 110 may also configure, based on the configuration control 314, a target action to be performed by a processing entity (e.g., “Agent 1”) corresponding to the node 304 upon determining that the agent is not suitable to process the request to be processed.

Illustratively, the electronic device 110 may provide a set of candidate actions, e.g., an action 316-1 and an action 316-2.

In some embodiments, the action 316-1 may indicate that a request to be processed is still to be processed by the first processing entity (e.g., “Agent 1”).

In some embodiments, the action 316-2 may indicate jumping to the third processing entity in a plurality of processing entities to process the request to be processed, the third processing entity is determined from other entities in a plurality of processing entities based on the request to be processed.

For example, in processing a request to be processed, the target application may determine a second processing entity suitable for processing the request to be processed according to the capabilities of other processing entities. Specifically, the target application may determine a predetermined number of a plurality of candidate processing entities from all other processing entities, and may further determine a second processing entity suitable for processing the particular processing request from a plurality of candidate processing entities by the first processing entity. In some embodiments, the predetermined number may be a number that is predetermined or may be determined based on user configuration information.

Similarly, the electronic device 110 may also configure, based on the configuration control 320, a target action to be performed by a processing entity (e.g., “Application 1”) corresponding to the node 318 upon determining that the processing entity is not suitable to process the request to be processed.

Similarly, the electronic device 110 may provide a set of candidate actions suitable for node 318, such as an action 322-1, an action 322-2, an action 322-3, and an action 322-4.

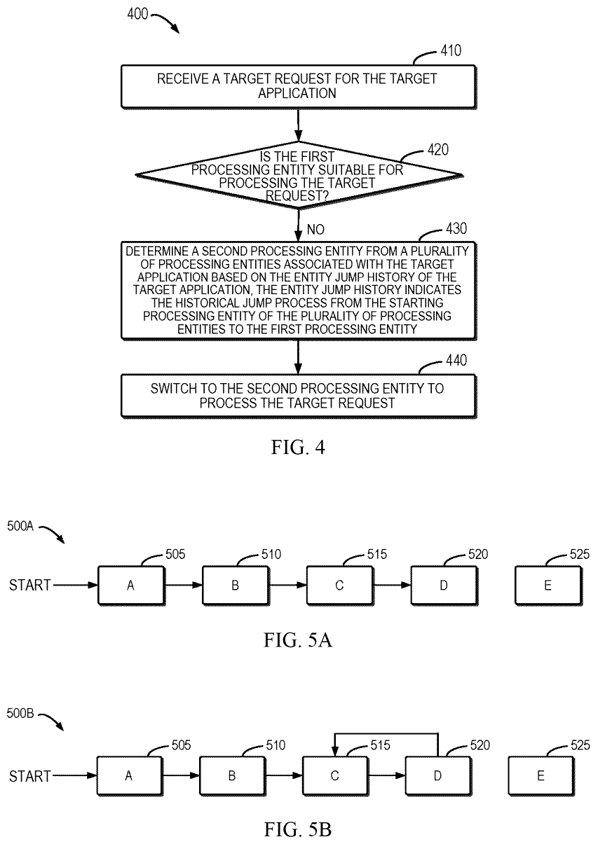

Different from node 304, since node 318 is not a starting node, the electronic device 110 may provide additional action options, e.g., an action 322-1 and an action 322-3. Specifically, in some embodiments, the action 322-1 may indicate jumping to a second processing entity of a plurality of processing entities to process a request to be processed, wherein the second processing entity is determined based on an entity jump history of a target application during operation. The specific process of determining the entity jump history and determining the second processing entity will be described below with reference to FIG. 4.

As another example, the action 322-3 may indicate jumping to a starting processing entity (e.g., “Agent 1” corresponding to starting node 304) of a plurality of processing entities to process a request to be processed.

In some embodiments, upon obtaining the configured target action via the configuration control 314 or the configuration control 320, a target application may create a target plug-in corresponding to a target action for a corresponding processing entity (e.g., “Agent 1” or “Application 1”) such that the processing entity may perform the corresponding target action by invoking the target plug-in.

Therefore, upon determining that the current first processing entity is not suitable for processing the request to be processed, the first processing entity may perform the target action configured by the configuration control 314 or the configuration control 320 via invoking a corresponding target plug-in.

In some embodiments, during execution, the target application may further update the plug-in description information of a target plug-in based on entity description information of at least one processing entity (e.g., starting processing entity, previous processing entity, or other appropriate processing entity) corresponding to a target action. As an example, the entity description information may comprise capability information or settings information of the second processing entity. Therefore, a first processing entity may determine whether to invoke a target plug-in based on the updated plug-in description information to trigger an execution of the corresponding action.

In some embodiments, in accordance with a determination that one or more of a plurality of conditions described below are met separately or simultaneously, the target application may determine that the current processing entity is not suitable for processing the request to be processed.

A first condition may comprise, for example, a determination that a level of matching between the prompt information of a current processing entity and a request to be processed is lower than a predetermined level. For example, the prompt information of the current processing entity may fail to recite any relevant description about the request.

A second condition may comprise, for example, prompt information of a current processing entity indicating that the current processing entity is incapable of processing the request to be processed. For example, the prompt information of the current processing entity explicitly indicating that it is not allowed to respond to requests of this type.

A third condition may comprise, for example, an ability of a current processing entity to process a request to be processed, comprising a knowledge capability or a plug-in capability. For example, the current processing entity may not be configured with a corresponding knowledge base or plug-in that is capable of responding to the request.

A fourth condition may comprise, for example, that a request is not of a generic type.

A fifth condition may comprise, for example, that a jump condition configured by a current processing entity fails to comprise a jump condition for resolving such request.

As an example, in the case where the above five conditions are satisfied, a current processing entity may determine that it is not suitable for processing the request to be processed, and may trigger a switch to another processing entity according to an action indicated by the configuration information accordingly.

Continuing to refer to FIG. 2, at block 220, the electronic device 110 creates a target application based on configuration information.

As an example, the electronic device 110 may create a corresponding target application, such as a bot, based on the configuration information. Furthermore, the bot may be published or shared with other users.

Based on the process described above, embodiments of the present disclosure are able to support a user to configure an action performed by a particular processing entity in response to determining that the particular entity is not suitable for processing the request, thereby improving the reliability of the application.

### Request Processing Process

FIG. 4 shows a flow chart of an example process 400 for processing a request in accordance with some embodiments of the present disclosure. The process 400 may be implemented at an electronic device 110 for operating a created target application.

As shown in FIG. 4, at block 410, the electronic device 110 receives a target request for a target application.

As an example, in response to that the target application is a conversation application, the target request may comprise a message input by the user to the conversation application.

At block 420, the electronic device 110 may determine whether the first processing entity associated with a target application is suitable for processing the target request.

In some embodiments, a target application may determine that a current processing entity is not suitable for processing a target request in accordance with a determination that one or more conditions of a plurality of conditions are met separately or simultaneously.

A first condition may comprise, for example, that a level of matching between a prompt information of a current processing entity and a target request is lower than a predetermined level.

A second condition may comprise, for example, that prompt information indicates that a current processing entity is incapable of processing a target request. For example, prompt information indicating that a current processing entity is not allowed to respond to this type of target request.

A third condition may comprise, for example, a current processing entity failing to be configured with a capability of processing the target request, wherein the capability comprises a knowledge capability or a plug-in capability. For example, a current processing entity failing to be configured with the corresponding knowledge base or plug-in that is capable of responding to the target request.

A fourth condition may comprise, for example, that the target request is not a generic type of request.

A fifth condition may comprise, for example, that a jump condition configured by a current processing entity fails to comprise a jump condition for resolving such target request.

As an example, in the case where the above five conditions are met, a target application may determine that a first processing entity is not suitable for processing the target request.

Continuing to refer to FIG. 4, in response to determining at block 420 that a first processing entity associated with a target application is not suitable for processing the target request, process 400 may proceed to block 430.

At block 430, the electronic device 110 determines a second processing entity of a plurality of processing entities associated with a target application based on an entity jump history of the target application, the entity jump history indicates a historical jump process from the starting processing entity of a plurality of processing entities to a first processing entity.

In some embodiments, the electronic device 110 may obtain configuration information of a first processing entity, which may indicate, for example, that the first processing entity may perform an operation of “jump to the previous node” if the first processing entity is not suitable for processing a target request.

Accordingly, the electronic device 110 may obtain an entity jump history of a target application. In some embodiments, the entity jump history may indicate that a second processing entity jumped to a first processing entity during operation in response to a particular request.

FIG. 5A shows a schematic diagram of 500A according to some embodiments of the present disclosure Taking FIG. 5A as an example, the target application may comprise, for example, a plurality of processing entities, i.e., processing entity 505, processing entity 510, processing entity 520, processing entity 525, and processing entity 530.

In some embodiments, a target application may record the historical jump process between processing entities. Taking FIG. 5A as an example, in response to processing a first request, if the target application jumps from processing entity 505 to processing entity 510 in response to a first request, the target application may record a corresponding jump process, for example, A→B.

Accordingly, in response to processing a second request, if the target application jumps from the processing entity 510 to the processing entity 515 in response to a second request, the target application may update a corresponding jump process, for example, A→B→C.

Accordingly, in response to processing a third request, if the target application jumps from the processing entity 515 to the processing entity 520 in response to a third request, the target application may update a corresponding jump process, for example, A→B→C→D.

In this case, the processing entity 520 used by a target application to process the target request may be configured with an action of “jumping to the previous node”, and the processing entity 520 is determined as not suitable for processing the target request. Correspondingly, the electronic device 110 may determine that the “previous node” is the processing entity 515 (i.e., the second processing entity) based on the historical jump process.

In some embodiments, in order to improve an efficiency of the recording historical jump process, the electronic device 110 may only record the initial processing entity and the response processing entity processing a particular request in the historical jump process.

For example, taking a received first request as an example, during a process of processing the first request, a target application sequentially jumps from the processing entity 505 to the processing entity 510 and jumps to the processing entity 515, and finally the processing entity 515 responds to the request. Correspondingly, a target application will record a direct jump from the processing entity 505 to the processing entity 515 (e.g., A→C), instead of recording all the processing entities (e.g., A→B→C).

In some embodiments, in order to improve the timeliness of a request response, a target application may configure, for example, an upper limit on a number of processing entities that a single request is allowed to jump. For example, the target application may determine a number of processing entities jumped during the processing of the target request. If the number reaches a threshold (for example, an upper limit of the number), the target application may utilize the current processing entity 520 to process the target request, regardless of whether the processing entity 520 is suitable for processing the target request.

On the contrary, if the number does not reach the threshold, the target application may determine the second processing entity to be jumped to based on the process described above, such as the processing entity 515.

In some embodiments, a target application may also avoid the target request forming a loop over the course of multiple jumps. Specifically, if a target request jumps starting from the processing entity 515 to the processing entity 520 and jumps back to the processing entity 515 again, the target application may block the jumping logic or the configured backtracking action corresponding to the processing entity 515 and may use the processing entity 515 to process the target request.

In some embodiments, if it is determined at block 420 that the first processing entity is suitable to process a target request, the target application may utilize the first processing entity to respond to the target request (not shown in FIG. 4).

Continuing to refer to FIG. 4, at block 440, the electronic device 110 switches to a second processing entity to process a target request.

Taking FIG. 5B as an example, a target application may, for example, switch to the processing entity 515 to process a target request.

Further, a target application may determine whether to jump to another processing entity based on configuration information such as the processing entity 515's capability, a jump condition, and an action to be performed if it is not suitable for processing a request.

As an example, in response to a target application finally using the processing entity 515 to respond to the target request, the target application updates the entity jump history of the target application accordingly.

For example, a target application may update the historical jump process represented by the entity jump history to: A→B→C→D→C.

In some embodiments, a target application may delete a portion corresponding to the loop from the historical jump process, taking into account the presence of a C-to-C loop in such a historical jump process. Specifically, the target application may determine whether the historical jump process from a starting processing entity to a first processing entity comprises a second processing entity.

In some embodiments, if a historical jump process comprises a second processing entity, the target application may determine a target part from the historical jump process, wherein the target part may correspond to the jump process from a starting processing entity to a second processing entity. For example, the target application may determine that an existing historical jump process (A→B→C→D) comprises a second processing entity (i.e., C), and the target application may determine a target part from the historical jump process from a starting processing entity (i.e., A) to a second processing entity (i.e., C), i.e., A→B→C. Furthermore, the target application may update an entity jump history based on the target part.

In other embodiments, if the historical jump process comprises a second processing entity, a target application adds a second processing entity to the historical jump process to update an entity jump history. For example, based on the example shown in FIG. 5A, if the processing entity 520 further jumps to the processing entity 525 in response to a target request, the historical jump process may be updated to: A→B→C→D→E.

As another example, based on the example shown in FIG. 5A, a target application may determine that the processing entity 520 needs to jump to the processing entity 510. Further, a second processing entity (e.g., processing entity 510) determined by the target application needs to perform additional jumps to determine a processing entity finally used for a corresponding target request.

Taking FIG. 5C as an example, the processing entity 515 may further jump to the processing entity 525 to respond to a target request, and the target application may finally jump to the processing entity 525 to respond to a subsequent request. In this case, a historical jump process may be updated to: A→B→C→E.

Based on the process described above, embodiments of the present disclosure may select other processing entities to continue processing a specific request based on an entity jump history of an application in response to determining that the processing entity is not suitable for processing the specific request. Therefore, embodiments of the present disclosure may improve the reliability of application processing a request.

### Example Devices and Equipment

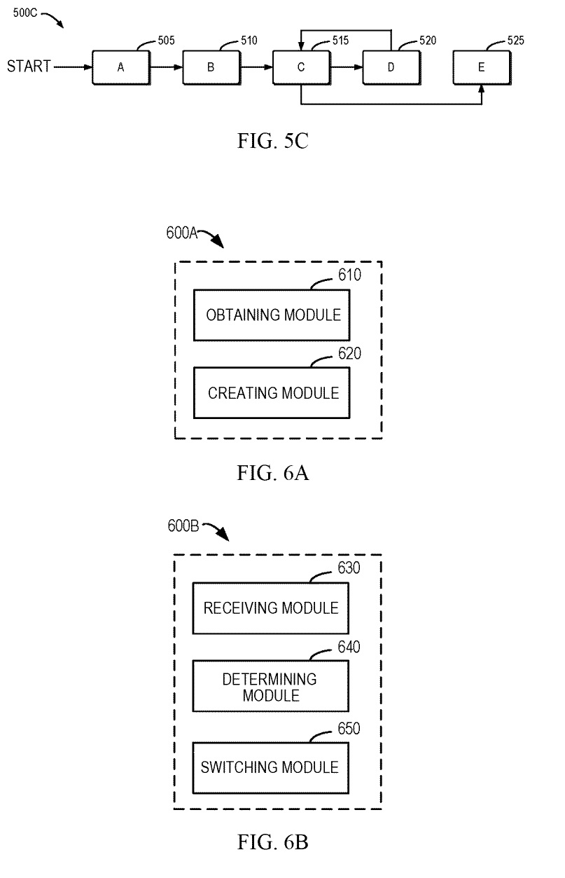

Embodiments of the present disclosure further provide a corresponding apparatus for the implementing of the above method or process. FIG. 6A shows a schematic block diagram of an example apparatus 600 for creating an application in accordance with certain embodiments of the present disclosure. The apparatus 600A may be implemented as or comprised in the electronic device 110.

As shown in FIG. 6A, the device 600A comprises an obtaining module 610 configured to obtain configuration information of a first processing entity associated with a target application to be created, the configuration information indicating the target action performed by the first processing entity in response to a determination that the application to be created is not suitable for processing a request to be processed, and a creating module 620 configured to create a target application based on the configuration information.

In some embodiments, a target action indicates jumping to a second processing entity in a plurality of processing entities to process the request to be processed, the second processing entity is determined based on an entity jump history of a target application during operation.

In some embodiments, the target action indicates jumping to a starting processing entity of a plurality of processing entities to process a request to be processed.

In some embodiments, a target action indicates jumping to a third processing entity of a plurality of processing entities to process the request to be processed, the third processing entity is determined from other entities of a plurality of processing entities based on the request to be processed.

In some embodiments, a target action indicates processing a request as still to be processed by a first processing entity.

In some embodiments, a first processing entity comprises an agent or a referenced application.

In some embodiments, in a case where at least one of the following conditions is met, a first processing entity is determined as not suitable for processing the request to be processed: a level of matching between prompt information of a first processing entity and a request to be processed is lower than a predetermined level; prompt information of a processing entity indicates that the first processing entity is unable to process a request to be processed; the first processing entity fails to be configured with a capability to process a request to be processed, the capability comprises a knowledge capability or a plug-in capability.

In some embodiments, a target application is configured to: create a target plug-in corresponding to a target action for a first processing entity based on a configuration information, such that the first processing entity is able to perform the target action by invoking the target plug-in.

In some embodiments, a target application is further configured to update plug-in description information of a target plug-in based on entity description information of at least one processing entity corresponding to a target action.

Embodiments of the present disclosure further provide a corresponding apparatus for implementing the method or process described above. FIG. 6B shows a schematic block diagram of an example apparatus 600 for processing requests in accordance with certain embodiments of the present disclosure. The apparatus 600B may be implemented as or comprised in the electronic device 110. Each of the modules/components in apparatus 600B may be implemented by hardware, software, firmware, or any combination thereof.

As shown in FIG. 6B, the apparatus 600B comprises a receiving module 630 configured to receive a target request for a target application; a determining module 640 configured to respond to a determination that a first processing entity associated the target application is not suitable for processing a target request, and based on the entity jump history of a target application, determine a second processing entity from a plurality of processing entities associated with a target application, and an entity jump history indicates the historical jump process from the starting processing entity of a plurality of processing entities to a first processing entity; and a switching module 650 configured to switch to a second processing entity to process a target request.

In some embodiments, the apparatus 600B further comprises an updating module configured to switch to a second processing entity based on the target application, and update an entity jump history.

In some embodiments, the updating module is further configured to: in response to a target application using a second processing entity to respond to a target request, determining whether a historical jump process from a starting processing entity to a first processing entity comprises a second processing entity; and in response to determining that a historical jump process fails to comprise a second processing entity, add a second processing entity to the historical jump process to update the entity jump history.

In some embodiments, the updating module is further configured to: in response to determining that a historical jump process comprises a second processing entity, determine a target part from the historical jump process, the target part corresponds to a jump process from a starting processing entity to a second processing entity jump; and based on the target part, update the entity jump history.

In some embodiments, the updating module is further configured to: in response to determining the target application using a third processing entity to respond to a target request, update an entity jump history to indicate a jump from a first processing entity to a third processing entity to respond to the target request, the third processing entity is different from the second processing entity.

In some embodiments, the historical jump process indicates that a second processing entity jumped to a first processing entity to respond to a particular request during operation.

In some embodiments, the determining module 640 is further configured to: determine a number of processing entities jumped in the process of processing a target request, in response to the number of processing entities being lower than a threshold number, and based on an entity jump history of a target application, determining a second processing entity from a plurality of processing entities associated with the target application.

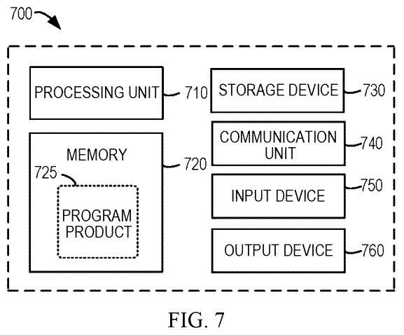

FIG. 7 shows a block diagram of an electronic device 700 in which one or more embodiments of the present disclosure may be implemented. It should be understood that the electronic device 700 shown in FIG. 7 is merely exemplary and should not constitute any limitation on the functionality and scope of the embodiments described herein. The electronic device 700 shown in FIG. 7 may be used to implement the electronic device 110 in FIG. 1.

As shown in FIG. 7, the electronic device 700 is in the form of a general-purpose electronic device. The components of the electronic device 700 may comprise, but are not limited to, one or more processors or processing units 710, memory 720, storage device 730, one or more communication units 740, one or more input devices 750, and one or more output devices 760. The processing units 710 may be actual or virtual processors and are capable of performing various processes according to programs stored in memory 720. In a multiprocessor system, multiple processing units execute computer-executable instructions in parallel to improve the parallel processing capability of the electronic device 700.

Electronic device 700 typically comprises a plurality of computer storage media. Such media may be any obtainable media accessible to electronic device 700, comprising but not limited to volatile and nonvolatile media, removable and non-removable media. Memory 720 may be volatile memory (such as registers, caches, random access memory (RAM)), nonvolatile memory (such as read-only memory (ROM), electrically erasable programmable read-only memory (EEPROM), flash memory), or certain combination thereof. Storage device 730 may be removable or non-removable media, and may comprise machine-readable media such as flash drives, disks, or any other media that may be used to store information and/or data and may be accessed within electronic device 700.

Electronic device 700 may further comprise additional removable/non-removable, volatile/nonvolatile storage media. although not shown in FIG. 7, disk drives for reading or writing from removable, nonvolatile disks (e.g., “floppy disks”) and optical disk drives for reading or writing from removable, nonvolatile optical discs may be provided in these cases, each drive may be connected to a bus (not shown) by one or more data media interfaces. The memory 720 may comprise a computer program product 725 having one or more program modules configured to perform various methods or actions of the various embodiments of the present disclosure.

The communication unit 740 realizes communication with other electronic devices via a communication medium. Additionally, the functions of the components of the electronic device 700 may be implemented in a single computing cluster or in a plurality of computing machines, which are capable of communicating through a communication connection. Therefore, the electronic device 700 may operate in a networked environment using a logical connection of one or more other servers, a network personal computer (PC), or another network node.

The input device 750 may be one or more input devices, such as a mouse, keyboard, trackball, etc. The output device 760 may be one or more output devices, such as a display, speaker, printer, etc. The electronic device 700 may also communicate with one or more external devices (not shown) via the communication unit 740 as needed, such as storage devices, display devices, etc., communicate with one or more devices that enable the user to interact with the electronic device 700, or communicate with any device (such as a network interface card, modem, etc.) that enables the electronic device 700 to communicate with one or more other electronic devices. Such communication may be performed via an input/output (I/O) interface (not shown).

According to some example implementations of the present disclosure, there is provided a computer-readable storage medium having stored thereon computer-executable instructions, wherein the computer-executable instructions are executed by a processor to perform operations that implement the methods described above. An exemplary embodiment of the present disclosure is also provided in which a computer program product is tangibly stored on a non-transient computer-readable medium and comprises computer-executable instructions, which are executed by a processor to implement the method described above.

Various aspects of the present disclosure are described here with reference to flowcharts and/or block diagrams of method, apparatus, device, and computer program product implemented in accordance with the present disclosure. It should be understood that each block of the flowcharts and/or block diagrams and combinations of blocks in the flowcharts and/or block diagrams may be implemented by computer-readable program instructions.

These computer-readable program instructions may be provided to a processing unit of a general-purpose computer, special-purpose computer, or other programmable data processing device to produce a machine that, when executed by a processing unit of a computer or other programmable data processing device, produces a device that implements the functions/actions specified in one or more blocks in the flowchart and/or block diagram. These computer-readable program instructions may also be stored in a computer-readable storage medium, which causes the computer, programmable data processing device, and/or other device to operate in a specific manner. Therefore, the computer-readable medium storing the instructions comprises an article of manufacture that comprises instructions for implementing various aspects of the functions/actions specified in one or more blocks in the flowchart and/or block diagram.

Computer-readable program instructions may be loaded onto a computer, other programmable data processing device, or other device to cause a series of operational steps to be performed on the computer, other programmable data processing device, or other device to produce a computer-implemented process, so that the instructions executed on the computer, other programmable data processing device, or other device perform operations that implement the functions/actions specified in one or more blocks in the flowchart and/or block diagram.

The flowcharts and block diagrams in the attached figures show the possible architecture, functions, and operations of the systems, methods, and computer program products implemented according to the present disclosure. In this regard, each block in the flowcharts or block diagrams may represent a module, program segment, or part of an instruction, which contains one or more executable instructions for implementing the specified logical functions. In some alternative implementations, the functions marked in the blocks may also occur in a different order than those marked in the figures. For example, two consecutive blocks may actually be executed in substantially parallel, and they may sometimes be executed in the opposite order, depending on the functions involved. It should also be noted that each block in the diagrams and/or flowcharts, as well as combinations of blocks in the diagrams and/or flowcharts, may be implemented using dedicated hardware-based systems that perform the specified functions or actions, or may be implemented using a combination of dedicated hardware and computer instructions.

The above has described various implementations of the present disclosure. The above description provides a number of examples, not exhaustive, and is not limited to the various implementations disclosed. Without departing from the scope and spirit of the various implementations described, many modifications and changes are obvious to ordinary technicians in this field. The choice of terms used in this article is intended to best explain the principles, practical applications, or improvements to the technology in the market, or to enable other ordinary technicians in this field to understand the various implementations disclosed in this article.

1. A method of creating an application, comprising:
obtaining configuration information of a first processing entity associated with a target application to be created, the target application to be created being associated with a plurality of processing entities, the configuration information indicating a target action to be performed by the first processing entity in response to a determination that the application to be created is not suitable for processing a request to be processed; and
creating the target application based on the configuration information.

2. The method according to claim 1, wherein the target action indicates jumping to a second processing entity of the plurality of processing entities to process the request to be processed, the second processing entity being determined based on an entity jump history of the target application.

3. The method according to claim 1, wherein the target action indicates jumping to a starting processing entity of the plurality of processing entities to process the request to be processed.

4. The method according to claim 1, wherein the target action indicates jumping to a third processing entity of the plurality of processing entities to process the request to be processed, the third processing entity being determined from other entities of the plurality of processing entities based on the request to be processed.

5. The method according to claim 1, wherein the target action indicates processing the request to be processed by the first processing entity.

6. The method according to claim 1, wherein the first processing entity comprises an agent or a referenced application.

7. The method according to claim 1, wherein the first processing entity is determined to be not suitable to process the request to be processed if at least one of the following conditions is met:
a level of matching between prompt information of the first processing entity and the request to be processed is lower than a predetermined level;
prompt information of the first processing entity indicates that the first processing entity is incapable of processing the request to be processed; or
the first processing entity fails to be configured with a capability to process the request to be processed, the capability comprising a knowledge capability or a plug-in capability.

8. The method according to claim 1, wherein the target application is configured to: create a target plug-in corresponding to the target action for the first processing entity based on the configuration information, such that the first processing entity is capable of performing the target action by invoking the target plug-in.

9. The method of claim 8, wherein the target application is further configured to:
update plug-in description information of the target plug-in based on entity description information of at least one processing entity corresponding to the target action.

10. A method of processing a request, comprising:
receiving target request for a target application;
in response to a determination that a first processing entity associated with a target application is not suitable for processing the target request, determining a second processing entity from a plurality of processing entities associated with the target application based on an entity jump history of a target application, the entity jump history indicating a historical jump process from a starting processing entity of the plurality of processing entities to the first processing entity; and
switching to the second processing entity to process the target request.

11. The method according to claim 10, further comprising:
based on the target application switching to the second processing entity, updating the entity jump history.

12. The method according to claim 11, wherein updating the entity jump history comprises:
in response to the target application responding to the target request using the second processing entity, determining whether the historical jump process from the starting processing entity to the first processing entity comprises the second processing entity; and
in response to determining that the historical jump process fails to comprise the second processing entity, adding the second processing entity to the historical jump process to update the entity jump history.

13. The method according to claim 11, wherein updating the entity jump history further comprises:
in response to determining that the historical jump process comprises the second processing entity, determining a target part from the historical jump process, the target part corresponding to a jump process from the starting processing entity to the second processing entity; and
updating the entity jump history based on the target part.

14. The method according to claim 11, wherein updating the entity jump history comprises:
in response to determining that the target application responds to the target request using a third processing entity, updating the entity jump history to indicate jumping from the first processing entity to the third processing entity to respond to the target request, the third processing entity being different from the second processing entity.

15. The method according to claim 10, wherein the historical jump process indicates that the second processing entity jumped to the first processing entity to respond to a particular request during operation.

16. The method according to claim 10, wherein determining a second processing entity from a plurality of processing entities associated with the target application based on an entity jump history of the target application comprises:
determining a number of processing entities jumped during a processing of the target request; and
in response to the number of processing entities being less than a threshold number, determining a second processing entity from a plurality of processing entities associated with the target application based on an entity jump history of the target application.

17. The method according to claim 16, further comprising:
in response to the number of processing entities reaching the threshold number, responding to the target request using the first processing entity.

18. An electronic device comprising:
at least one processing unit; and
at least one memory, the at least one memory being coupled to the at least one processing unit and storing instructions for execution by the at least one processing unit, upon executed by the at least one processing unit, the instructions causing the electronic device to perform operations configured to create an application, the operations comprising:
obtaining configuration information of a first processing entity associated with a target application to be created, the target application to be created being associated with a plurality of processing entities, the configuration information indicating a target action to be performed by the first processing entity in response to a determination that the application to be created is not suitable for processing a request to be processed; and
creating the target application based on the configuration information.
